(19) United States
(12) Patent Application Publication
(10) Pub. No.: US 2005/0141104 A1
(43) Pub. Date: Jun. 30, 2005

(54) Image sensor

(75) Inventor: Chang Young Hong, Kyunggido (KR)

Correspondence Address: THE LAW OFFICES OF ANDREW D. FORTNEY, PH.D., P.C., 7257 N. MAPLE AVENUE, BLDG. D, 3107, FRESNO, CA, 93720, US

(73) Assignee: DongbuAnam Semiconductor Inc.

(21) Appl. No.: 11/021,616

(22) Filed: Dec. 24, 2004

(30) Foreign Application Priority Data
Dec. 27, 2003 (KR) 10-2003-0098107

(51) Int. Cl. G02B 17/00

(52) U.S. Cl. 359/727

(57) ABSTRACT

An image sensor is disclosed, in which a light shielding layer is positioned in a circumference of a microlens array, and the light shielding layer has a thickness greater than that of the microlens array, to prevent a contaminant blocking sealing tape from directly contacting the microlens array and support the sealing tape, thereby avoiding damage to the microlens array when pressure is applied to press the sealing tape and/or polish a back surface of a semiconductor substrate. If such damage is prevented, the light converging function of the microlens array may be optimized, and the quality of the image reproduced by the image sensor can also be improved, substantially.

### CROSS-REFERENCE TO RELATED APPLICATIONS

This application claims the benefit of Korean Application No. P2003-0098107 filed on Dec. 27, 2003, which is hereby incorporated by reference as if fully set forth herein.

### BACKGROUND OF THE INVENTION

1. Field of the Invention

The present invention relates to image sensors, and more particularly, to an image sensor in which a light shielding layer is shifted to or located in a circumference of a microlens array, and a thickness of the light shielding layer is greater than a thickness of the microlens array, to prevent a contaminant blocking sealing tape from being brought into direct contact with the microlens array in advance by supporting action of the light shielding layer, and for reducing or avoiding damage to the microlens array easily, for example when a pressure is conventionally applied to the microlens array to press the sealing tape strongly, or during polishing of a back surface of a semiconductor substrate.

2. Discussion of the Related Art

Recently, as electric and electronic technologies are developed rapidly, a variety of electronic products include image sensor technologies, such as video cameras, digital cameras, PCs with built-in miniature cameras, cellular phones with built-in miniature cameras, and so on, are developed, and spread widely.

Traditionally, Charge Coupled Devices (CCD) have been used as the image sensors. However, the CCD has many disadvantages, such as a high driving voltage, and an additional separate supporting circuit is generally required. Thus, the process cost for CCDs is high, and as a result, the present trend in the use of the CCD is decreasing.

Recently, as image sensors that can replace the CCD, Complementary Metal Oxide Semiconductor (CMOS) image sensors attract much interest. Different from the present CCD, because the CMOS image sensors are fabricated based on CMOS circuit technologies, the CMOS image sensors have advantages in that low voltage driving is possible, no additional supporting circuit is required, a process cost is low, and so on.

Referring to FIG. 1, a conventional CMOS image sensor is provided with a microlens array 7 for converging an external light incident thereon, a color filter array 6 for converting the light converged by the microlens array 7 into a color light, a planarizing layer 5 on the color filter array 6 for planarizing a base of the microlens array 7 to induce uniform light transmission, a light transmission layer 4 for transmission of the light converted into the color light at the color filter layer 7 toward a photodiode array 3, and the photodiode array 3 on an active region of a semiconductor substrate 1 defined by an active cell isolation layer 2, for receiving the light passed through the light transmission layer 4, to produce and store photo charges. In addition to this, there is a light shielding layer 8 at an outermost circumference of the color filter array 6 for shielding an external unnecessary light incident on the photodiode array 3, a signal processing circuit block (not shown), and the like.

In a conventional process, in order to fabricate a light, thin, short, and small sized image sensor, a back surface of a semiconductor substrate 1 is spin polished to reduce a total thickness of the image sensor. However, the polishing inevitably produces many silicon particles from the back surface 1a of the semiconductor substrate, which move toward a surface of the semiconductor substrate 1 due to static electricity generated during the spin polishing, resulting in contamination of various structures on the image sensor.

Referring to FIG. 2, for preventing such a problem, a sealing tape 101 is attached to the surface of the image sensor, to block or otherwise prevent the various CMOS image sensor structures from being contaminated with the silicon particles. However, when the back surface 1a of the semiconductor substrate 1 is polished, a polishing tool (not shown) applies a pressure to the surface of the image sensor, which sometimes forms a curvature damaged surface 7a as shown in FIG. 3, if other measures are not taken.

Of course, if the curvature damaged surface 7a is left as it is without taking any measures, the microlens array 7 fails to perform a regular light converging function, leading to an image reproduction of which quality is poor.

### SUMMARY OF THE INVENTION

Accordingly, the present invention is directed to an image sensor that substantially obviates one or more problems due to limitations and disadvantages of the related art.

An object of the present invention is to provide an image sensor, in which a light shielding layer is shifted to or located in a circumference of the microlens array, and a thickness of the light shielding layer is greater than a thickness of the microlens array, to prevent a contaminant blocking sealing tape from being brought into direct contact with the microlens array. The supporting action of the light shielding layer is believed to avoid or reduce damage to the microlens array, even if a pressure is applied to the microlens array to press the sealing tape strongly during polishing of a back surface of the semiconductor substrate.

Another object of the present invention is to provide an image sensor, in which damage to a microlens array which may result from polishing of a back surface of a semiconductor substrate and inadvertent contact with a sealing tape is prevented, to maintain or optimize a light converging function of the microlens array and/or substantially improve or maintain a quality of the image reproduced by the image sensor.

Additional advantages, objects, and features of the invention will be set forth in part in the description which follows and in part will become apparent to those having skill in the art upon examination of the following or may be learned from practice of the invention. The objectives and other advantages of the invention may be realized and attained by the structure particularly pointed out in the written description and claims hereof as well as the appended drawings, as well as variations thereof that are apparent to those skilled in the art.

To achieve these objects and other advantages and in accordance with the purpose of the invention, as embodied and broadly described herein, an image sensor includes a microlens array for converging an external light incident thereon, an optional color filter array for converting the light converged by the microlens array into a color light, a photodiode array on a semiconductor substrate at an active region, for receiving the light converged by the microlens array and to produce and store photo charges, an optional light transmission layer over the semiconductor substrate to cover the photodiode array, to support the microlens array and the (optional) color filter array, and to transmit the light converged by the microlens array toward the photodiode array, and a light shielding support layer at a circumference of the microlens array, adapted to shield an external light, support an external particle shielding tape if attached, and prevent or inhibit the microlens array from being brought into physical contact with the tape.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and which are incorporated in and which constitute a part of this application, illustrate embodiment(s) of the invention and together with the description serve to explain the principle of the invention. In the drawings:

FIG. 1 illustrates a cross-section showing an example of a conventional image sensor;

FIG. 2 illustrates a cross-section showing an example of a contact state of a conventional image sensor to a sealing tape;

FIG. 3 illustrates a cross-section conceptually showing an example of a damaged state of a conventional microlens array;

FIG. 4 illustrates a section showing an example of an image sensor in accordance with a preferred embodiment of the present invention;

FIG. 5A illustrates a perspective view showing an example of a contact state of an image sensor to a sealing tape in accordance with a preferred embodiment of the present invention; and

FIG. 5B illustrates a section along a line A1-A2 in FIG. 5A, with the sealing tape in place along the periphery of the microlens array.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

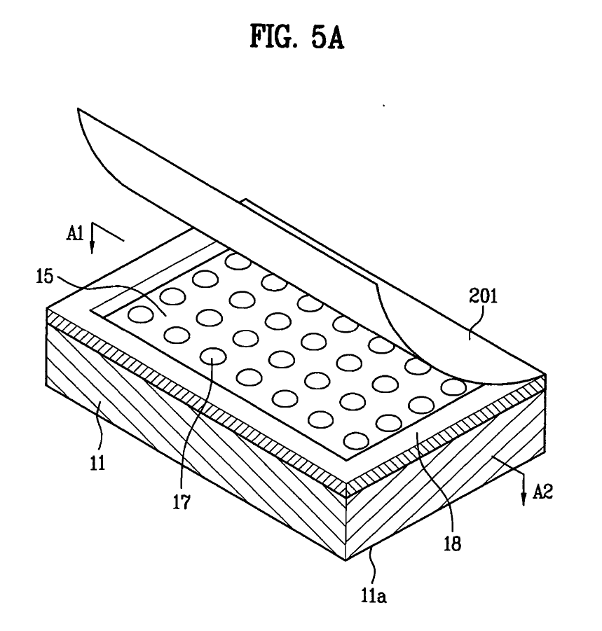

Referring to FIG. 4, the image sensor, for an example, a CMOS image sensor, includes a microlens array 17 for converging an external light incident thereon, a color filter array 16 for converting the light converged by the microlens array 17 into a color light, a light transmission layer 14 for transmission of the light converted into the color light at the color filter layer 17 toward a photodiode array 13, and the photodiode array 13 on an active region of a semiconductor substrate 11 defined by an active cell isolation layer 12, for receiving the light passed through the light transmission layer 14 and producing and storing photo charges. The light transmission layer 14 is formed over the semiconductor substrate 11 to cover the photodiode array 13 and to support the microlens array 17 and the color filter array 16.

In the present invention, as described before, in order to fabricate a light, thin, short, and small sized image sensor on the whole, a back surface 11a of the semiconductor substrate 11 is spin polished to reduce a total thickness of the image sensor. Of course, the polishing inevitably produces many silicon particles from the back surface 11a of the semiconductor substrate 11, which may move toward a surface of the semiconductor substrate 11 due to static electricity generated during the spin polishing, resulting in contamination of various structures of the image sensor.

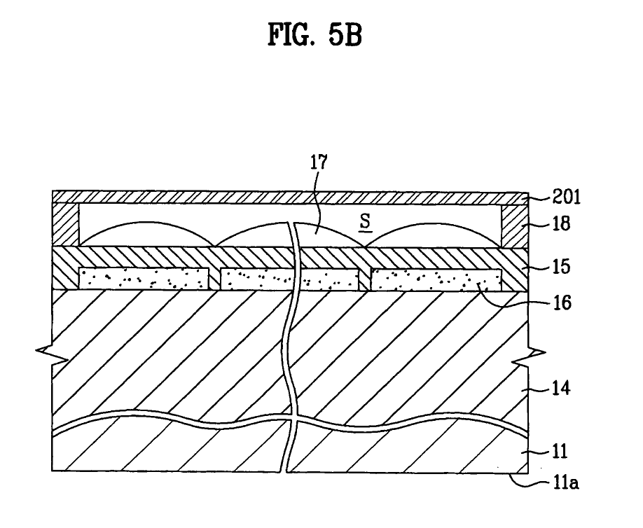

Referring to FIGS. 5A and 5B, for preventing such a problem in the present invention, a particle blocking sealing tape 201 is attached to the surface of the image sensor, to prevent and/or block the various structures from being contaminated with the silicon particles. In this instance, as described before, if the back surface 11a of the semiconductor substrate 11 is polished when the sealing tape 201 covers the surface of the image sensor, the polishing tool applies a pressure to the surface of the image sensor, which may form a curvature damaged surface on microlenses in microlens array 17, if other measures are not taken.

As shown in the drawings, in the present invention, a light shielding support layer 18 is formed in a circumference region of the microlens array 17, surrounding the microlens array 17. The light shielding support layer 18 is adapted to shield external light incident on the photodiode array 13, and generally comprises (i) a conventional thermoplastic resin that does not deform substantially at a temperature less than about 300° C. and (ii) a colored pigment selected to absorb light of a wavelength or wavelength band from which circuitry is to be shielded. Light shielding support layer 18 may further shield a signal processing block and/or other structures and/or circuits located under the circumference region of the microlens array 17.

Referring back to FIG. 4, in this instance, a planarizing layer 15 on an underside of the light shielding supporting layer 18 may be adapted or configured to cover the light transmission layer 14, and planarize a base of the microlens array 17 and the light shielding supporting layer 18. Thus, planarizing layer 15 preferably has a planar upper surface on which microlens array 17 and light shielding supporting layer 18 may be formed adjacent to one another. Furthermore, planarizing layer 15 preferably is formed (e.g., deposited) such that it covers the upper and side surfaces of color filter array 16.

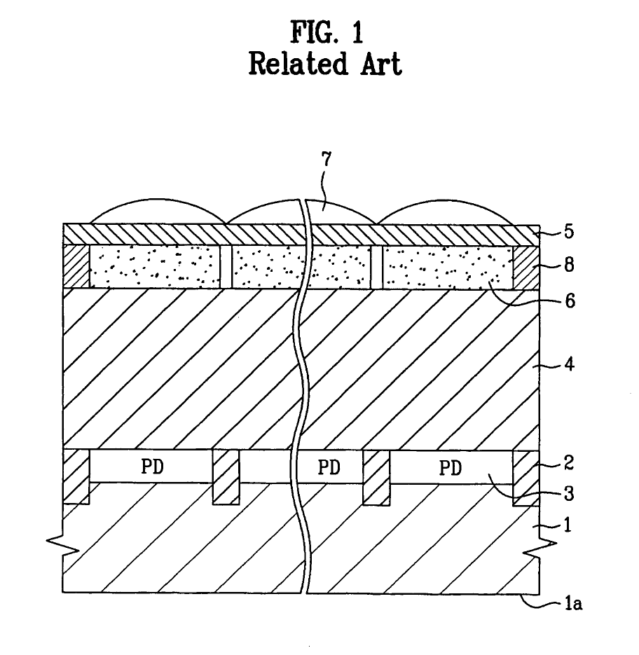

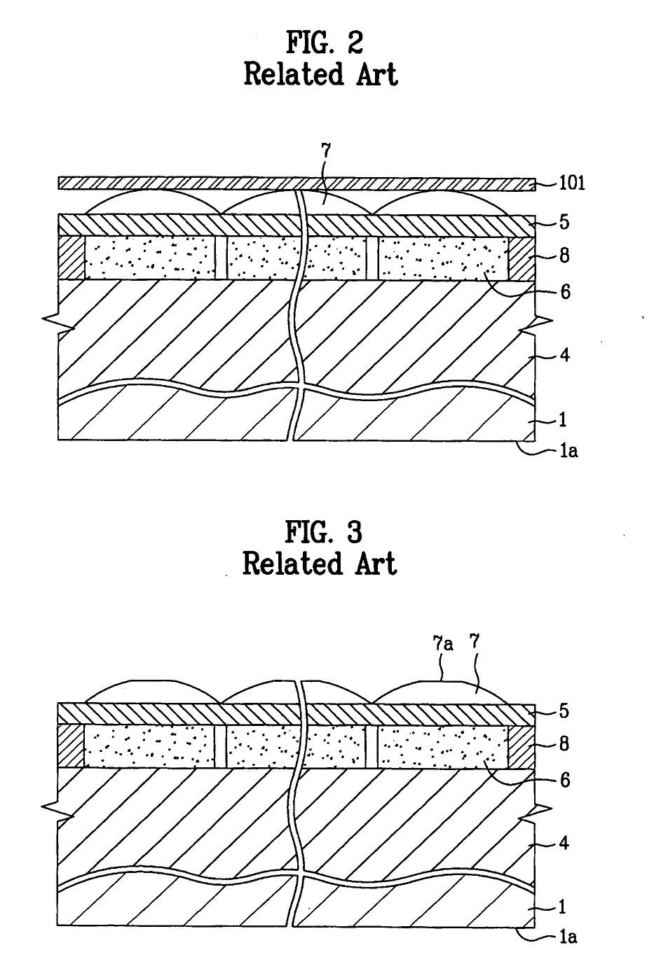

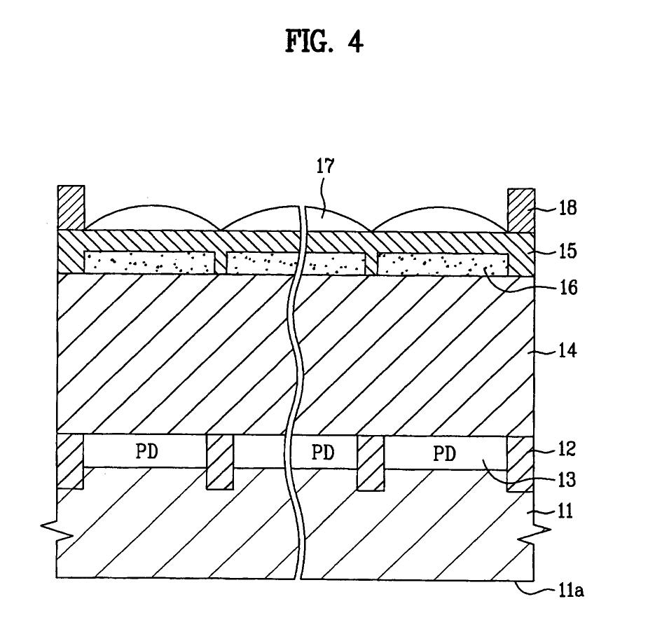

As shown in the drawings, different from the related art light shielding layer 8 (see FIGS. 1-3), the light shielding supporting layer 18 of the present invention (see FIG. 4) has a thickness relatively greater than the microlens array 17, preferably by 1.5˜2.5 times.

In this instance, referring to FIG. 5B, different from the related art, the sealing tape 201 is attached to the light shielding support layer 18 of the CMOS image sensor for blocking external particles. Thus, the sealing tape 201 does not contact with the microlens array 17 directly, but is supported by the light shielding support layer 18, with a gap ‘S’ between the sealing tape 201 and, the microlens array 17. In this state, when the back surface 11a of the semiconductor substrate 11 is polished, and a pressure is applied to the upper surface of the image sensor from the polishing tool, the microlens array 17 can avoid direct physical contact with the sealing tape 201 easily, minimizing and/or avoiding damage that may be caused by contact with the sealing tape 210.

By improving the related art image sensor, damage to the microlens array 17 that may be caused by polishing of the back surface of the semiconductor substrate 11 and/or by contact of the sealing tape 201 may be reduced or avoided. Thus, the light converging function of the microlens array 17 can be optimized naturally (e.g., without accounting or adjusting for damage to the lenses in microlens array 17), leading to an improved quality of reproduced images.

Once the total thickness of the image sensor is reduced by polishing (sometimes called “back grinding” in the art), the sealing tape may be removed, various structures of the image sensor may be connected to outside parts electrically, and an outside exposure lens may be fitted, to complete fabrication of the image sensor or (micro)camera containing the same.

As has been described, by positioning the light shielding layer in a circumference of the microlens array and/or adjacent to the microlens array, and forming the light shielding layer such that its thickness is greater than a corresponding thickness of the microlens array, the contaminant blocking sealing tape may be supported by the light shielding layer and prevented from directly contacting the microlens array, thereby reducing or avoiding damage to the microlens array when pressure is applied to the image sensor to press the sealing tape and/or during polishing of the back surface of the semiconductor substrate. If such damage to the microlens array is reduced or prevented, the light converging function of the microlens array may be optimized, and the quality of the image reproduced by the image sensor can be improved.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. An image sensor comprising:
a microlens array adapted to converge an external light incident thereon;
a photodiode array on a semiconductor substrate at an active region, adapted to receive the light converged by the microlens array, and to produce and store photo charges; and
a light shielding support layer in a circumference region of the microlens array, adapted to shield an external light.

2. The image sensor as claimed in claim 1, further comprising a color filter array adapted to convert the light converged by the microlens array into color light.

3. The image sensor as claimed in claim 1, further comprising a light transmission layer over the semiconductor substrate to cover the photodiode array, adapted to support the microlens array and the color filter array, and transmit the light converged by the microlens array to the photodiode array.

4. The image sensor as claimed in claim 1, further comprising a planarizing layer on the light transmission layer adapted to provide a planar base for the microlens array and the light shielding support layer.

5. The image sensor as claimed in claim 1, wherein the light shielding support layer has a thickness greater than that of the microlens array.

6. The image sensor as claimed in claim 5, wherein the light shielding support layer has a thickness 1.5˜2.5 times thicker than the microlens array.

7. The image sensor as claimed in claim 1, wherein the light shielding support layer is further adapted to protect the microlens array.

8. The image sensor as claimed in claim 1, wherein the light shielding support layer is coplanar with the microlens array.

9. The image sensor as claimed in claim 1, wherein the light shielding support layer is further adapted to support an external particle shielding tape and prevent or inhibit the microlens array from physically contacting the tape.

10. A method of making a CMOS image sensor comprising the steps of:
forming a photodiode array in an active region of a semiconductor substrate;
forming a microlens array over the photodiode array, the microlens array being adapted to converge an external light incident thereon; and
forming a light shielding support layer in a circumference region adjacent to the microlens array, adapted to shield an external light.

11. The method as claimed in claim 10, further comprising, prior to the microlens array forming step, forming a color filter array adapted to convert the light converged by the microlens array into color light.

12. The method as claimed in claim 11, further comprising, prior to the color filter array forming step, forming a light transmission layer covering the photodiode array, adapted to support the microlens array and the color filter array, and transmit the light converged by the microlens array to the photodiode array.

13. The method as claimed in claim 10, further comprising forming a planarizing layer over the photodiode array, the planarizing layer being adapted to provide a planar base for the microlens array and the light shielding support layer.

14. The method as claimed in claim 10, wherein the light shielding support layer has a thickness greater than that of the microlens array.

15. The method as claimed in claim 14, wherein the light shielding support layer has a thickness 1.5˜2.5 times thicker than the microlens array.

16. The method as claimed in claim 10, further comprising attaching a sealing tape to the light shielding support layer, the sealing tape being adapted to protect the microlens array.

17. The method as claimed in claim 16, further comprising, after the sealing tape attaching step, backgrinding the substrate.
